(19) United States
(12) Patent Application Publication
(10) Pub. No.: US 2002/0134842 A1
(43) Pub. Date: Sep. 26, 2002

(54) Medium body comprising a security element

(76) Inventor: Olivier Brunet, Marseille (FR)

Correspondence Address: BURNS DOANE SWECKER & MATHIS L L P, POST OFFICE BOX 1404, ALEXANDRIA, VA, 22313-1404, US

(21) Appl. No.: 09/890,691

(22) PCT Filed: Dec. 6, 2000
(86) PCT No.: PCT/FR00/03403

(30) Foreign Application Priority Data
Dec. 6, 1999 (FR) 99/15356

(51) Int. Cl. G06K 19/00

(52) U.S. Cl. 235/487

(57) ABSTRACT

The invention relates to a method of protecting a document information carrier body such as an identity card and/or a smart card, characterised in that it includes the following steps:

producing an electronic label comprising an integrated circuit security chip fixed to a heat transfer ribbon;

fixing the electronic label to the carrier body by hot pressing of the transfer ribbon, and then;

personalising the carrier body and the corresponding electronic label.

An information carrier body comprising a security element containing an integrated circuit chip

The present invention relates to the protection of an information carrier body, such as a smart card or an identity card.

The carrier body according to the present invention incorporates an authentication element containing an integrated circuit chip, this element being fixed to the surface of the carrier body.

The personal nature of certain information carriers such as smart cards or identity cards does not need to be demonstrated. It is consequently important to provide such carriers with a security element which makes it possible to recognise the authenticity of the carrier. The essential function of this security element is to limit fraud on the carriers.

There already exist certain security elements such as holograms or chequered printing for example. Such elements are produced on the carrier body during the process of manufacturing the latter.

It does however turn out that the possibility of placing a security element only at the end of the carrier body manufacturing process makes it possible to limit the problems of theft on the production sites.

In fact it would be advantageous to place the security element only in the centres for personalising the information carrier bodies. Thus these centres which receive blank carrier bodies could directly deposit the security element at the same time as they effect the personalisation of the carriers.

The company G&D has thus developed a protected laser personalisation effected directly in the personalisation centres. An area with cells in relief was previously produced on the surface of the carrier body during its manufacture. Two laser personalisations are then effected simultaneously with two different angles of incidence in order to obtain a personalisation of the “movie” type which reveals different information according to the inclination of the card with respect to the eye.

The invention proposes another method of protecting an information carrier body in which the security element is deposited at the end of the manufacturing process, that is to say directly in the personalisation centres.

In addition, the invention proposes to use an electronic security element which affords many functions other than the simple recognition of a fraud. The electronic security element can in fact carry information relating to the bearer of the carrier body.

The present invention consists more specifically of a method of protecting an information carrier body such as an identity card and/or a smart card, characterised in that it includes the following steps:

producing an electronic label comprising an integrated circuit security chip fixed to a heat transfer ribbon;

fixing the electronic label to the carrier body by hot pressing of the transfer ribbon, and then;

personalising the carrier body and the corresponding electronic label.

According to one characteristic, the chip of the electronic label is manufactured with a technology making it possible to have a small thickness.

According to another characteristic, the chip of the electronic label is connected to an integral antenna.

According to a variant embodiment, the chip of the electronic label is coated with a heat-activated glue on the face in contact with the carrier body.

According to one embodiment, the electronic label is deposited on the carrier body by means of a cutting and pressure tool able to activate the adhesive properties of the transfer ribbon.

According to one characteristic, the cutting tool reveals a pattern in the contours of the label.

According to a variant embodiment, the cutting tool has a recessed space in the shape of the chip so as to take the thickness of the chip when the label is deposited on the carrier body.

According to another variant embodiment, the cutting tool is produced from deformable material so as to take the excess thickness of the chip when the label is deposited on the carrier body.

According to one characteristic, the electronic label has scoring which tears easily.

According to another characteristic, a serial number is applied to the label, the same number being applied to the carrier body.

According to another characteristic, the method includes a step of laser marking of a pattern straddling the label and the carrier body.

According to another characteristic, the method includes a step of producing a hologram on the label.

The present invention also relates to a carrier body having an authentication or security element, characterised in that the said element includes an integrated circuit chip fixed to the surface of the document carrier body.

According to one characteristic, the chip is thin.

According to another characteristic, the chip is fixed to the document carrier body by a transfer adhesive.

According to one application, the carrier body is an identity card.

According to another application, the carrier body is a protected smart card containing a first working chip, and at least one second security chip fixed to the surface of the card body, the said security chip containing electronic authentication elements.

The method according to the invention advantageously makes it possible to place the security or authentication element of the carrier only at the end of the manufacturing process. Thus no modification of the industrial processes is necessary.

The use of an electronic security element makes it possible to store data relating to the bearer of the carrier, whether it is a case of an identity card or a smart card.

In addition, the personalisation of the document carrier can be accomplished at the same time as that of the chip, at the end of the manufacturing process.

The risk of theft is thus limited on the production sites, and the costs of protecting the document carriers can be reduced.

Other particularities and advantages of the present invention will emerge during the following description given by way of illustrative and non-limitative examples, and made with reference to the figures, in which:

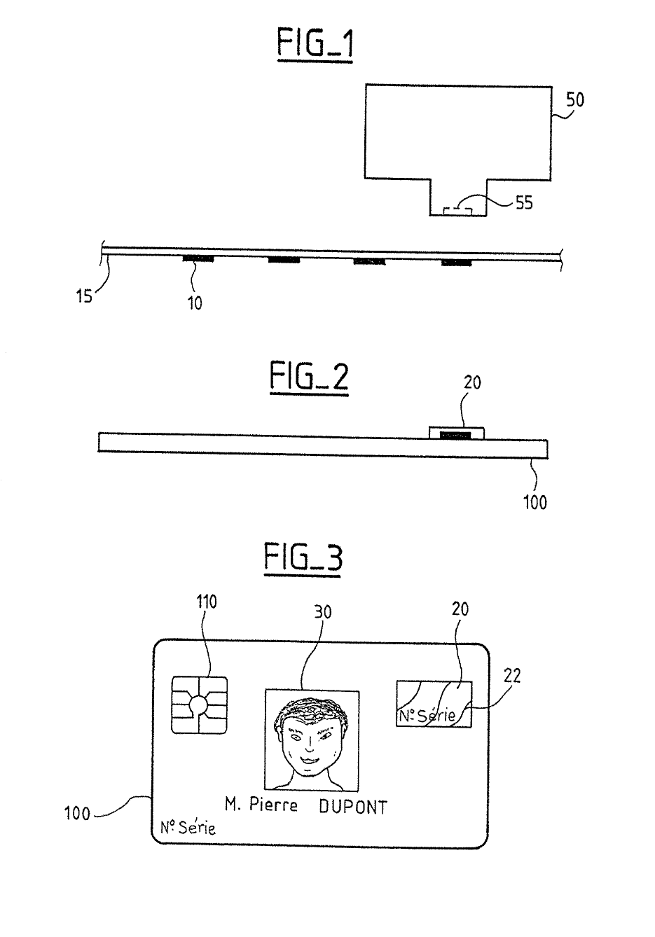

FIG. 1 is a schematic view in section of the step of cutting the electronic labels according to the method of the invention,

FIG. 2 is a schematic view in section of a carrier body provided with an authentication element according to the invention,

FIG. 3 is a schematic plan view of a carrier body provided with an authentication element according to the invention.

The present invention consists in placing on an information carrier body an electronic security or authentication element.

For this purpose, the invention proposes a protection method comprising a first step of producing an electronic label, followed by a step of depositing this label on the carrier body, and a final step of personalisation of the carrier and of the label.

FIG. 1 illustrates the first step of the method according to the invention. Integrated circuit chips 10 are fixed to a thermal transfer ribbon 15, and electronic labels are individualised by cutting the ribbon 15 by means of an adapted tool 50.

Chips 10 used in the context of the invention are preferentially chips provided with an integral antenna, etched for example. In addition, these chips are advantageously thinned according to the KOPIN technology known to experts. This technology, described in the patent application WO-A-98/02921, makes it possible to obtain integrated circuit chips with an overall thickness of around 10 μm, or even less. At this thickness, the chips are flexible and transparent.

These chips 10 are then fixed, by gluing for example, to a thermal transfer ribbon 15. Such a ribbon has adhesive properties activated by hot pressing. The adhesive of the ribbon 15 can include a thermosetting phase to prevent it unsticking. Such a ribbon is well known to experts by the English term of “hot stamping”.

The ribbon 15 is then cut by means of a cutting tool 50 in order to individualise the electronic labels 20 and to attach each of them to a carrier body 100, as illustrated in FIG. 2. Such a tool 50 is normally used for effecting the hot bonding of a heat transfer ribbon.

According to a variant embodiment, the chip 10 can be coated with a heat-activated glue on its face which has to be in contact with the carrier body 100. This variant makes it practically impossible to pull off the label 20 without pulling off the electronics of the security element 20.

According to one particularity of the invention, the cutting and pressing tool 50 can be provided with a cavity 55 in order to take the excess thickness of the chip 10 during the cutting and pressing of the ribbon 15 on the body 100. It may also be envisaged producing a portion of the tool 50 from a deformable material in order to take this excess thickness of the chip 10.

According to another particularity of the invention, the cutting tool 50 can have a shape corresponding to a particular pattern to be given to the label 20.

In addition, the cutting tool 50 generally has a small size and an easy method of use, which makes it possible to perform the step of depositing the labels 20 on the carrier bodies 100 directly in personalisation centres.

FIG. 3 illustrates a schematic plan view of the carrier body according to the invention.

According to the application, the carrier body can consist of an identity card and/or a smart card and/or any other document carrier requiring a security or authentication element.

The security element or any object, composed of the electronic label 20, is stuck to the surface of the card 100 directly in the personalisation centre which is sending the card 100 to its bearer.

This makes it possible to considerably reduce the risk of theft on production sites, since the cards are provided with an authentication label 20 only at the end of the manufacturing process, just before being sent to their bearer, at the same time as the gluing or printing of a photo 30, for example.

It can also be envisaged producing smart cards provided with a first working chip 110, and comprising an authentication element 20 according to the invention.

The chip 10 of the security label 20 can also contain personalised information relating to the bearer in addition to authentication information.

In order to mask the integrated circuit chip 10 of the label 20, preferably an opaque transfer ribbon 15 is used.

Nevertheless, for other applications, it is possible to choose to produce a transparent label 20, in particular when the chip 10 used is very small and very thin. It is thus possible to glue the security label 20 to an identity photograph for example.

In addition, the use of thinner chips 10 for producing the security labels 20 makes it possible to keep a standard carrier thickness 100. Thus, in the case of a smart card for example, the latter can be inserted in a reader without the security label 20 being damaged.

In order to limit the risk of fraud, several methods can be used, alone or in combination:

The electronic label 20 can have scores 22 tearing easily if it is sought to replace it.

The same serial number can be applied to the label 20 and to the body 100, when the label 20 is deposited in the personalisation centre.

A step of marking a complex pattern by laser straddling the label and the carrier body, or producing a hologram, can be added.

The label 20 can include any security element known to experts, such as a hologram, a printing with ink visible under ultraviolet or infrared, or any other means.

1. A method of protecting an information carrier body (100) such as an identity card and/or a smart card, characterised in that it includes the following steps:
producing an electronic label (20) comprising an integrated circuit security chip (10) fixed to a heat transfer ribbon (15);
fixing the electronic label (20) to the carrier body (100) by hot pressing of the transfer ribbon (15), and then;
personalising the carrier body (100) and the corresponding electronic label (20).

2. A protection method according to claim 1, characterised in that the chip (10) of the electronic label (20) is manufactured with a technology making it possible to have a small thickness.

3. A protection method according to one of claims 1 to 2, characterised in that the chip (10) of the electronic label (20) is connected to an integral antenna.

4. A protection method according to any one of the preceding claims, characterised in that the chip (10) of the electronic label (20) is coated with a heat-activated glue on the face in contact with the carrier body (100).

5. A protection method according to any one of the preceding claims, characterised in that the electronic label (20) is deposited on the carrier body (100) by means of a cutting and pressure tool (50) able to activate the adhesive properties of the transfer ribbon (15).

6. A protection method according to claim 5, characterised in that the cutting tool (50) reveals a pattern in the contours of the label (20).

7. A protection method according to one of claims 5 to 6, characterised in that the cutting tool (50) has a recessed cavity (55) in the same shape as the chip (10) so as to take the thickness of the chip when the label (20) is deposited on the carrier body (100).

8. A protection method according to one of claims 5 to 6, characterised in that the cutting tool (50) is produced from deformable material so as to take the excess thickness of the chip (10) when the label (20) is deposited on the carrier body (100).

9. A protection method according to any one of the preceding claims, characterised in that the electronic label (20) has scores (22) tearing easily.

10. A protection method according to any one of the preceding claims, characterised in that a serial number is applied to the label (20), the same number being applied to the support body (100).

11. A protection method according to any one of the preceding claims, characterised in that it includes a step of laser marking of a pattern straddling the label (20) and the carrier body (100).

12. A protection method according to any one of the preceding claims, characterised in that it includes a step of producing a hologram on the label (20).

13. An information carrier body (100) containing an authentication or security element (20), characterised in that the said element (20) contains an integrated circuit chip (10) fixed to the surface of the said information carrier body (100).

14. An information carrier body (100) according to claim 13, characterised in that the said element (20) is fixed by adhesive to the said surface.

15. An information carrier body (100) according to one of claims 13 and 14, characterised in that said integrated circuit chip (10) is connected to an integral antenna.

16. An information carrier body (100) according to one of claims 13 to 15, characterised in that the said integrated circuit chip (10) is fixed to the said information carrier body (100) by a transfer adhesive (15).

17. An information carrier body (100) according to one of claims 13 to 16, characterised in that it constitutes an identity card.

18. An information carrier body (100) according to one of claims 13 to 17, characterised in that it consists of a protected smart card containing a first working chip (110), and at least a second security chip (20) fixed to the surface of the said card (100), the said security chip (20) containing electronic authentication elements.

19. An information carrier body (100) according to claim 18, characterised in that the said security chip (20) is not in electrical contact with the said working chip (110).
